(19) United States
(12) Patent Application Publication
(10) Pub. No.: US 2008/0245049 A1
(43) Pub. Date: Oct. 9, 2008

(54) Coupling element for a shackle

(76) Inventor: Agyd Pengg, Klagenfurt (AT)

Correspondence Address: RATNERPRESTIA, P O BOX 980, VALLEY FORGE, PA, 19482-0980, US

(21) Appl. No.: 11/732,977

(22) Filed: Apr. 5, 2007

(51) Int. Cl. F16G 15/02

(52) U.S. Cl. 59/86

(57) ABSTRACT

A coupling element of a shackle for load-carrying elements, such as chains, hooks, or the like, is disclosed. The coupling element has two substantially parallel legs, whose free ends each have a bore for the accommodation of a connecting bolt, by means of which the coupling element can be linked to another coupling element of the same design to form the shackle, the coupling elements being held together only by the connecting bolt, which bores extend in the same direction relatively to each other, wherein the bores are out-of-line and extend at an angle to a longitudinal center line of the coupling element.

### FIELD OF THE INVENTION

The invention relates to a coupling element of a shackle for load-carrying elements, such as chains, hooks, or the like, which coupling element exhibits two legs extending substantially parallel to each other and whose free ends each have a bore for the accommodation of a connecting bolt, by means of which the coupling element can be connected to another coupling element of the same design to form the shackle. The coupling elements are linked only by the connecting bolts and the bores extend in the same direction relatively to each other. Furthermore, the invention relates to a shackle having two coupling elements interconnected by means of a connecting bolt.

### BACKGROUND OF THE INVENTION

Shackles of the present type are usually employed for connecting chains or lashing means, etc. to each other or to corresponding fittings, such as hooks, shackles, etc. EP 009 2382 discloses a shackle which has a first and a second coupling element, which elements each have a cusp region and parallel legs extending away from said cusp region. The end regions of the legs are equipped with a bore for the accommodation of a connecting bolt, the ends of the first coupling element being enclosed by the ends of the second coupling element. A disadvantage of the known embodiment is primarily that it is necessary, due to their construction, to use two differently designed coupling elements, which increases the manufacturing costs considerably. Furthermore, the connecting bolt is subjected to high bending stresses, due to its design, which causes drawbacks with respect to the strength properties.

A shackle of the aforementioned type, which has become known under the name “Connex” and has been disclosed in AT 001 926 U1, is illustrated in FIG. 1. This shackle VER has two interconnected coupling elements VE1, VE2 having a substantially U-shaped cross-region, one end EN1 of a leg SC1 of a coupling element VE1 forming a forked head, into which an end region EN2 of a leg SC2 of the other coupling element VE2 can be introduced. The end regions EN1, EN2 each have a bore in which, in the assembled state, a connecting bolt VBZ is accommodated. A disadvantage of this shackle is that it involves very elaborate production, because the parts have to be forged in order to acquire the required load-bearing capacity.

DE 22 00 381 A shows a chain link for the production of a disconnectable connection of round link chains. This known chain link has two identical link halves, of which each consists of a bracket having an inner leg and an outer leg. The two brackets are held together by teeth on the inner and outer brackets, and additionally a locking bolt is provided which passes through the inner and outer brackets of the link halves via bores extending in-line and at an angle to a longitudinal central plane. However, the locking pin does not hold the two link halves together, but merely serves to prevent the teeth of the inner and outer brackets from disengaging. A disadvantage of this embodiment is primarily that it is relatively complicated to produce by reason of the teeth on the inner and outer brackets.

### SUMMARY OF THE INVENTION

The present invention provides a shackle which is simple and cheap to produce and, in addition, has more favorable strength properties than the known shackles. This is achieved, according to the invention, with a coupling element of the type defined above in which the bores are out-of-line relatively to each other and extend at an angle to a longitudinal center line of the coupling element.

A benefit of the invention is that it provides a coupling element which can be assembled with a similarly designed coupling element by means of a connecting bolt to form a shackle, while, by reason of the slanting configuration of the connecting bolt through the inclined bores, the bending stresses on the connecting bolt can be substantially reduced.

In an exemplary embodiment of the invention, a coupling element of a shackle for load-carrying elements comprises two substantially parallel legs, whose free ends have a bore for the accommodation of a connecting bolt, by means of which the coupling element can be linked to another coupling element of the same design to form the shackle. The coupling elements are held together only by the connecting bolt. The bores of the coupling elements extend in the same direction relatively to each other. The bores are out-of-line and extend at an angle to a longitudinal center line of the coupling element. The axis of the bores is at an acute angle to the longitudinal center line of the coupling element, which angle is greater than the angle of friction between the connecting bolt and the bores.

Further advantages can be achieved by making the end regions in which the bores are disposed less thick than the region of the coupling element which connects said end regions together. This can also be achieved with a shackle of the type mentioned above, in which the coupling elements connected by the connecting bolt are designed as defined in any one of the claims.

### BRIEF DESCRIPTION OF THE DRAWINGS

The invention, together with further advantages thereof, is explained in greater detail below with reference to some non-restricting exemplary embodiments illustrated in the drawings, in which:

FIG. 1 is front elevational view of a shackle according to the prior art;

FIG. 2 is a perspective view of a shackle according to an exemplary embodiment of the present of the invention and

FIG. 3 is a longitudinal cross-sectional view of the shackle shown in FIG. 2.

### DETAILED DESCRIPTION OF THE INVENTION

Certain terminology is used in the following description for convenience only and is not limiting. The terminology includes words specifically mentioned, derivatives thereof and words of similar import. The exemplary embodiment illustrated below is not intended to be exhaustive or to limit the invention to the precise form disclosed. This embodiment is chosen and described to best explain the principle of the invention and its application in practical use and to enable others skilled in the art to best utilize the invention.

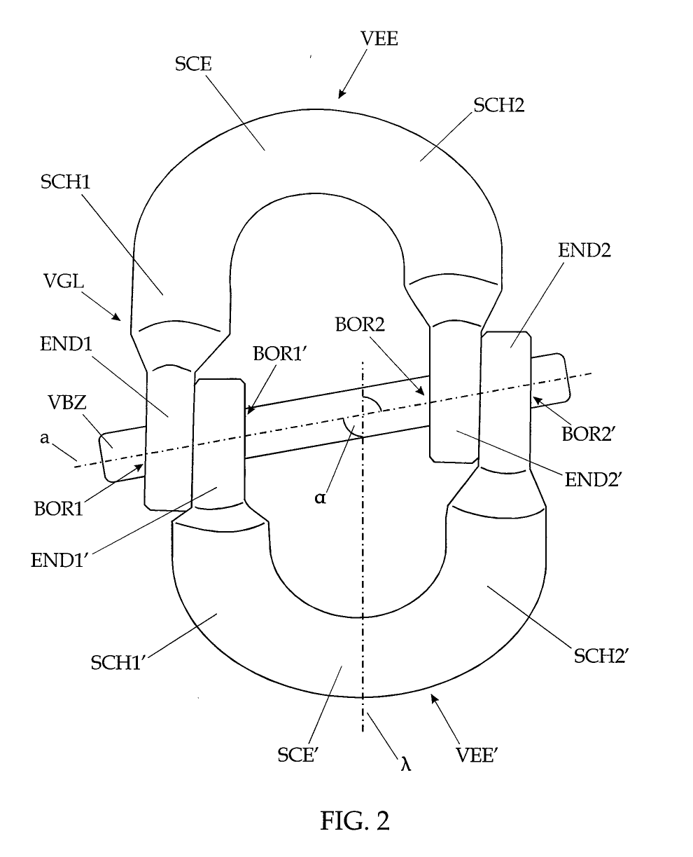

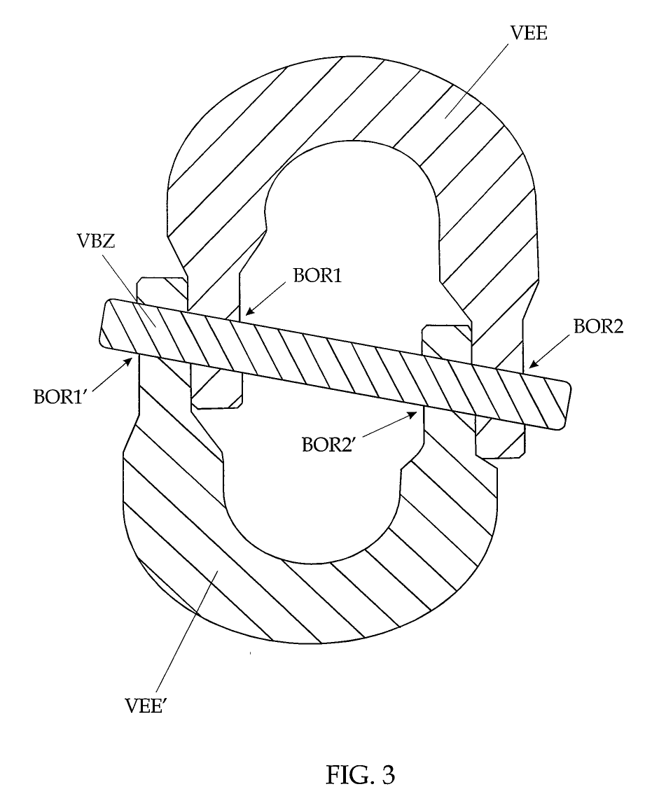

According to FIGS. 2 and 3, a shackle of the invention VGL has two coupling elements VEE, VEE′ of substantially U-shaped cross-region. Each coupling element VEE, VEE′ has a cusp region SCE, SCE′ and two legs SCH1, SCH2, SCH1′, SCH2′ extending therefrom. At each of the free ends END1, END2, END1′ END2′ of the legs SCH1, SCH2, SCH1′, SCH2′ there is provided a bore BOR1, BOR2, BOR1′, BOR2′, which bores BOR1, BOR2, BOR1′, BOR2′ of a coupling element VEE, VEE′ extend in the same direction relatively to each other. Furthermore, the bores BOR1, BOR2, BOR1′, BOR2′ of a coupling element VEE, VEE′ are out of line in the direction of a longitudinal center line λ of the coupling element VEE or VEE′ and thus in the longitudinal direction of its legs SCH1, SCH2, SCH1′, SCH2′ and extend at an angle to said longitudinal center line λ.

The two coupling elements VEE, VEE′ are held together by means of a connecting bolt VBZ to form the shackle VGL.

The axis a of the bores BOR1, BOR2, BOR1′, BOR2′ extends at an acute angle α to the longitudinal center line λ of the coupling element VEE or VEE′. The angle α is greater than the angle of friction between the connecting bolt VBZ and the bores BOR1, BOR2, BOR1′, BOR2′. The two legs SCH1, SCH2, SCH1′, SCH2′ of each coupling element VEE, VEE′ can be of different lengths, the end regions END1, END2, END1′, END2′ being less thick than the region located between the end regions END1, END2, END1′, END2′. Preferably, the angle α is just large enough to allow the coupling elements VEE, VEE′ to slip on the connecting bolt VBZ, since this can improve the load distribution on the legs SCH1, SCH2, SCH1′, SCH2′.

The slanting arrangement of the connecting bolt VBZ allows the end regions END1, END2, END1′, END2′ of the coupling elements VEE, VEE′ to slip toward each other, by which means a gap possibly present between the ends END1, END2, END1′, END2′ of the two coupling elements VEE, VEE′ during assembly can be automatically closed, which means that the manufacturing tolerances for a coupling element of the invention are increased over those allowed for the known coupling elements or shackles.

The connecting bolt VBZ can be secured against accidental slipping by means of a safety element (not shown), which has one or more safety sleeves surrounding the connecting bolt VBZ. The safety sleeve(s) can in turn be secured against slipping along the longitudinal axis a of the connecting bolt VBZ by means of an arresting spring mounted in an annular groove extending around the connecting bolt VBZ.

The connecting bolt VBZ can alternatively be protected from slipping out by means of a safety element of the type disclosed in the AT 001 926 U1 cited above.

It has been found that the solution provided by the invention can substantially reduce the load on the connecting bolt VBZ. Furthermore, the total strength of the shackle can be increased thereby over that of the known shackles. Moreover, it is of advantage that the coupling elements VEE, VEE′ can be manufactured as bent wire parts instead of as forged parts as commonly used hitherto, this also provides the possibility of recalibrating the coupling elements VEE, VEE′.

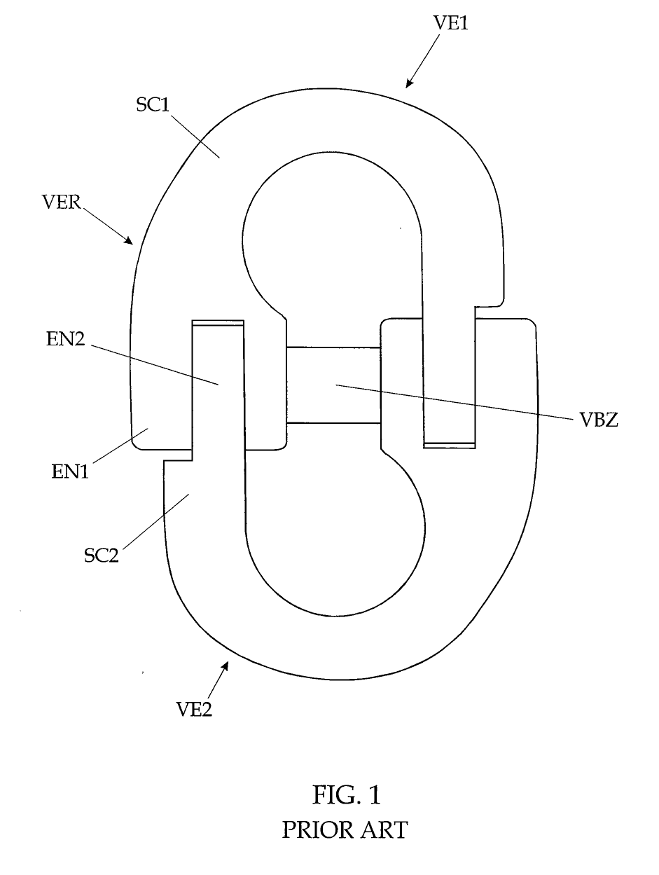

Naturally, the free ends of a coupling element VEE, VEE′ can form forked heads, if desired, as is known in the prior art (FIG. 1). An inventive feature, however, is that the connecting bolts are at an angle. That is to say, the axis a of the bores and thus of the connecting bolt VBZ desirably extends at an angle to the longitudinal center line λ of the shackle VEE′ or VEE.

Although the invention is illustrated and described herein with reference to specific embodiments, the invention is not intended to be limited to the details shown. Rather, various modifications may be made in the details within the scope and range of equivalents of the claims and without departing from the invention.

1. A coupling element of a shackle for load-carrying elements comprising two substantially parallel legs, free ends of said parallel legs each having a bore for the accommodation of a connecting bolt, by means of which the coupling element can be linked to another coupling element of the same design to form the shackle, said coupling elements being held together only by said connecting bolt, which bores extend in the same direction relatively to each other, wherein the bores are out-of-line and extend at an angle to a longitudinal center line of said coupling element.

2. The coupling element according to claim 1, wherein the axis of said bores extends at an acute angle to said longitudinal center line of said coupling element, which angle is greater than an angle of friction between said connecting bolt and said bores.

3. The coupling element according to claim 1, wherein said legs are of different lengths.

4. The coupling element according to claim 1, wherein the free ends in which said bores are disposed, are each less thick than a region of said coupling element that connects said free ends.

5. A shackle for load-carrying elements, comprising two coupling elements as defined in claim 1, said coupling elements being connected by means of a connecting bolt.

6. The coupling element according to claim 2, wherein said legs are of different lengths.

7. The coupling element according to claim 6, wherein the free ends in which said bores are disposed, are each less thick than a region of said coupling element that connects said free ends.

8. The coupling element according to claim 2, wherein the free ends in which said bores are disposed, are each less thick than a region of said coupling element that connects said free ends.

9. The coupling element according to claim 3, wherein the free ends in which said bores are disposed, are each less thick than a region of said coupling element that connects said free ends.

10. A shackle for load-carrying elements, comprising two coupling elements as defined in claim 2, said coupling elements being connected by means of a connecting bolt.

11. A shackle for load-carrying elements, comprising two coupling elements as defined in claim 3, said coupling elements being connected by means of a connecting bolt.

12. A shackle for load-carrying elements, comprising two coupling elements as defined in claim 4, said coupling elements being connected by means of a connecting bolt.

13. A shackle for load-carrying elements, comprising two coupling elements as defined in claim 6, said coupling elements being connected by means of a connecting bolt, whenever said coupling elements are designed as defined in claim 6.

14. A shackle for load-carrying elements, comprising two coupling elements as defined in claim 7, said coupling elements being connected by means of a connecting bolt.

15. A shackle for load-carrying elements, comprising two coupling elements as defined in claim 8, said coupling elements being connected by means of a connecting bolt.

16. A shackle for load-carrying elements, comprising two coupling elements as defined in claim 9, said coupling elements being connected by means of a connecting bolt.
